(19) United States
(12) Patent Application Publication
(10) Pub. No.: US 2015/0153514 A1
(43) Pub. Date: Jun. 4, 2015

(54) OPTICAL CONNECTOR

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); TOYOTA JIDOSHA KABUSHIKI KAISHA, Toyota-shi, Aichi-ken (JP)

(72) Inventors: Kosuke Sone, Yokkaichi-shi (JP); Takahito Nakashima, Toyota-shi (JP); Hiroshi Kobayashi, Toyota-shi (JP); Ato Nakano, Toyota-shi (JP)

(21) Appl. No.: 14/416,144

(22) PCT Filed: Jul. 11, 2013
(86) PCT No.: PCT/JP2013/068950

§ 371 Date: Jan. 21, 2015

(30) Foreign Application Priority Data
Jul. 24, 2012 (JP) 2012-163561

(51) Int. Cl. G02B 6/38

(52) U.S. Cl. CPC G02B 6/3807

(57) ABSTRACT

An optical connector includes a pair of optical connectors including a board-side connector and an opposite-side connector fitted with each other. The board-side connector includes an accommodating portion configured to internally fit with an opposite-side housing of the opposite-side connector and having an opening toward the front. The accommodating portion includes an elastically deformable shutter configured to elastically fall toward the back side of the accommodating portion to open the opening of the accommodating portion by being pressed by the opposite-side housing when the board-side connector and the opposite-side connector are fitted with each other. The shutter closes the opening of the accommodating portion when the housing and the opposite-side housing are detached from each other.

### TECHNICAL FIELD

The present invention relates to an optical connector provided with a shutter.

### BACKGROUND ART

An optical connector described in Patent Document 1 is known as a conventional optical connector including a housing in which a ferrule attached to an end of an optical fiber is housed. The optical connector is provided with a shutter for blocking light output from the optical fiber and for suppressing the entry of dust into an accommodating portion in which the ferrule is housed. The shutter has a plate-like shape and is rotatably assembled onto an opening portion of the accommodating portion in the housing.

The shutter is configured to be rotatable between a closed position where the shutter enters and intersects the optical path of the output light and thus closes the opening portion of the accommodating portion, and an open position where the shutter is withdrawn from the optical path of the output light and becomes parallel with the optical path and thus opens the opening portion. When the housing is fitted with an opposite-side housing, the shutter is pressed backward in a fitting direction by the opposite-side housing and is thereby rotated to the open position. The shutter then opens the accommodating portion and thereby allows the output light to be passed toward the opposite-side housing. When the opposite-side housing and the housing are detached from each other, the shutter is rotated to the closed position as the pressing caused by the opposite-side housing is released and the shutter is biased by a spring member assembled onto the shutter. As a result, the accommodating portion is closed, preventing the entry of dust and blocking the output light.

### CITATION LIST

Patent Document

Patent Document 1: JP 2002-267887 A

### SUMMARY OF INVENTION

### Technical Problem

In the above configuration, the shutter needs to be biased by the spring member from the open position to the closed position, resulting in an increase in the size of the optical connector. The number of components also increases, whereby the shutter structure becomes complex. As a result, the number of assembly steps is increased, raising the manufacturing cost for the optical connector.

The present invention was made in view of the above circumstances, and an object of the present invention is to provide a technique for suppressing the entry of dust into an accommodating portion of an optical connector while suppressing an increase in the size of the optical connector by decreasing the number of components.

### Solution to Problem

As a means for achieving the object, the present invention provides an optical connector that includes a pair of optical connectors including one connector and the other connector to be fitted with each other, the one connector including an accommodating portion configured to internally fit with the other connector and having an opening toward the other connector, and the accommodating portion being provided with an elastically deformable shutter. The shutter is configured to elastically fall toward a back side of the accommodating portion and to open the opening of the accommodating portion by being pressed by the other connector when the one connector and the other connector are fitted with each other. The shutter is configured to close the opening of the accommodating portion by entering an entry route of the other connector when the other connector is detached.

In the optical connectors having such configuration, when the connectors are fitted with each other, the shutter elastically falls to open the opening of the accommodating portion. When the connectors are detached from each other, the shutter closes the opening of the accommodating portion, preventing the entry of dust into the accommodating portion. The configuration also simplifies the shutter mechanism and enables a significant decrease in the number of members. Thus, an increase in the size of the optical connector or the number of assembly steps can be suppressed. Further, the manufacturing cost for the optical connector can be decreased.

The present invention may be embodied with the following preferable configurations.

The other connector may include a catching portion configured to catch the shutter so as to draw the shutter from the back side of the accommodating portion toward the outside of the accommodating portion when the one connector and the other connector are detached from each other.

In this configuration, even if the shutter remains fallen in the accommodating portion and cannot close the opening of the accommodating portion solely by the elastic returning force of the shutter, the catching portion facilitates the elastic return of the shutter by catching and drawing the shutter toward the outside. In this way, the opening of the accommodating portion can be reliably closed by the shutter.

The opening of the accommodating portion may have a substantially rectangular shape. The shutter may be made of a plate-like elastic member and be integrally firmly attached to one side of an opening edge of the accommodating portion.

In this configuration, the shutter is integrally firmly attached to the accommodating portion by, for example, welding or attaching with an adhesive the shutter to the opening edge of the accommodating portion, thus eliminating the need for separately providing a fixing member, such as a pin or a hinge, for attaching the shutter to the housing. Thus, the shutter attachment structure can be further simplified. Because the shutter is formed in plate-like shape, there is no need to provide a large space for locating the shutter when the shutter is fallen in the accommodating portion, suppressing an increase in the overall size of the optical connector.

The shutter may be made of a rubber material. In this configuration, the shutter can be inexpensively manufactured. Further, the shutter can be easily opened and closed by the elastic returning force of the rubber material.

The shutter may include a covering portion configured to cover the opening edge of the accommodating portion from outside.

In this configuration, the opening of the accommodating portion can be closed by covering the opening edge of the accommodating portion from outside. Thus, the shutter is less likely to be disposed with an inclination toward the open position side. In this way, compared with a case where the shutter is not provided with the covering portion, entry of dust into the accommodating portion can be reliably suppressed.

The other connector may include a catching portion, the covering portion may be formed to be slightly spaced apart from an inner wall of the accommodating portion when the shutter is elastically fallen toward the back side of the accommodating portion, and the catching portion may be configured to draw the shutter by catching the covering portion.

In this configuration, the catching of the shutter by the catching portion is facilitated. Because the covering portion configured to cover the opening edge of the accommodating portion also serves as an engaged portion to be caught by the catching portion, there is no need to provide the shutter with a separate engaged portion. Thus, an increase in the size of the optical connector can be suppressed, and the manufacturing cost for the optical connector can be decreased.

### Advantageous Effects of Invention

According to the present invention, entry of dust into the accommodating portion can be suppressed while suppressing an increase in the size of the optical connector by decreasing the number of components.

### BRIEF DESCRIPTION OF DRAWINGS

FIG. 1 is a perspective view of a board-side connector.

FIG. 2 is an exploded perspective view of the board-side connector.

FIG. 3 is a cross sectional view of the board-side connector and an opposite-side connector fitted with each other.

FIG. 4 is a cross sectional view of the board-side connector from which the opposite-side connector is slightly detached.

FIG. 5 is a cross sectional view of the board-side connector from which the opposite-side connector is detached by more than half.

FIG. 6 is a cross sectional view of the board-side connector from which the opposite-side connector is completely detached.

### DESCRIPTION OF EMBODIMENTS

### Embodiment

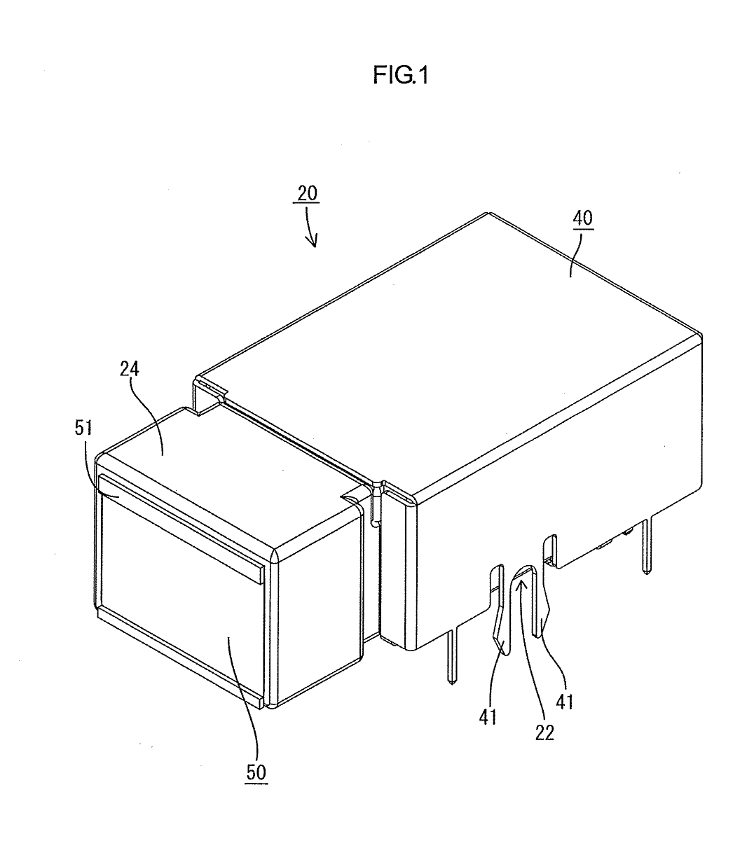

An embodiment of the present invention will be described with reference to FIGS. 1 to 6.

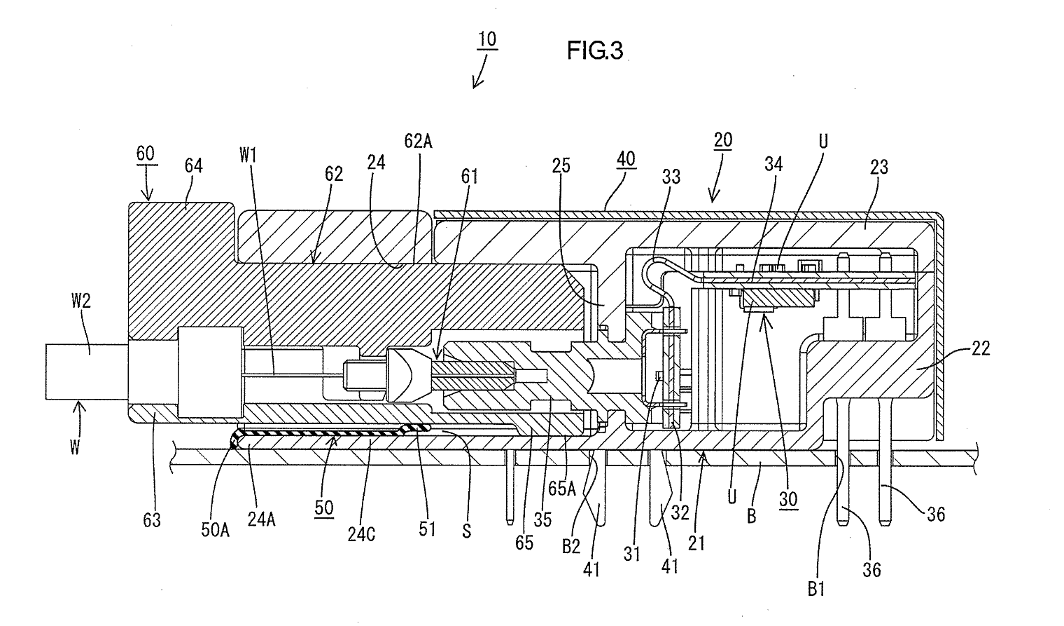

The present embodiment illustrates an optical connector 10 provided with a board-side connector (an example of “one connector”) 20 fixed to an outer board B, and with an opposite-side connector (an example of “the other connector”) 60 configured to be fitted with the board-side connector 20. In the following description, an upper-lower direction is with reference to the upper-lower direction of FIG. 3, a front-rear direction is with reference to the left-right direction of FIG. 3, and a front is the side of each of the connectors 20 and 60 that fits with the counterpart.

As illustrated in FIGS. 3 to 6, the opposite-side connector 60 includes a ferrule 61 connected to an end of an optical cord W, and an opposite-side housing 62 housing the ferrule 61.

The ferrule 61 has a substantially cylindrical shape and is fixed, at the end of the optical cord W, to an optical fiber W1 where a sheath W2 is removed.

The opposite-side housing 62 is made of synthetic resin and includes a lower housing 63 configured to place the ferrule 61 thereon, and an upper housing 64 assembled onto the lower housing 63 from above. The upper housing 64 is assembled, from above, onto the lower housing 63 on which the ferrule 61 is placed. The upper housing 64 is integrally assembled onto the lower housing 63 by being locked by a locking mechanism (not illustrated), which is disposed between the lower housing 63 and the upper housing 64. The ferrule 61 placed on the lower housing 63 is held by the lower housing 63 and the upper housing 64 from above and below, whereby the ferrule 61 is prevented from being pulled out of the opposite-side housing 62.

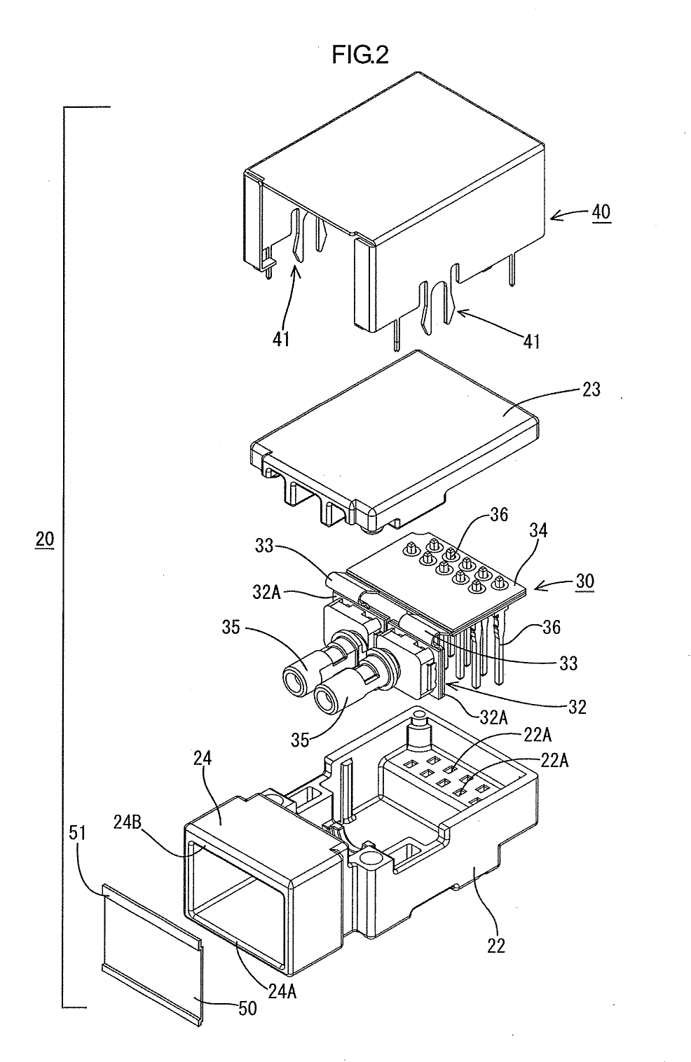

As illustrated in FIGS. 1 and 2, the board-side connector 20 includes a synthetic resin housing 21, an optical connection member 30 housed in the housing 21, and a shield shell 40 covering the housing 21.

The housing 21 has the shape of a box with a front opening, and includes a housing body portion 22 with an upper opening and a lid portion 23 closing the upper opening of the housing body portion 22. The housing body portion 22 includes an accommodating portion 24 with a substantially rectangular opening toward the front (toward the opposite-side connector 60). The accommodating portion 24 is configured such that the opposite-side housing 62 can be fitted into the accommodating portion 24 via the front-side opening. When the accommodating portion 24 and the opposite-side housing 62 are fitted with each other normally, more than half of the opposite-side housing 62 is housed in the accommodating portion 24, as illustrated in FIG. 3. To the rear of the accommodating portion 24 in the housing 21, there is housed the optical connection member 30.

As illustrated in FIGS. 3 to 6, the optical connection member 30 includes a first inner board 32 including a photoelectric conversion element 31 mounted thereon; a second inner board 34 connected to the first inner board 32 via flexible printed circuit boards 33; and a pair of sleeve members 35 fixed to the first inner board 32.

The second inner board 34 is disposed to the rear of the optical connection member 30 and includes layered printed circuit boards with conductive paths formed on the upper and lower surfaces of the flexible printed circuit board 33 by printed wiring technology. On each of the upper and lower surfaces of the second inner board 34, there is mounted a plurality of electronic components U.

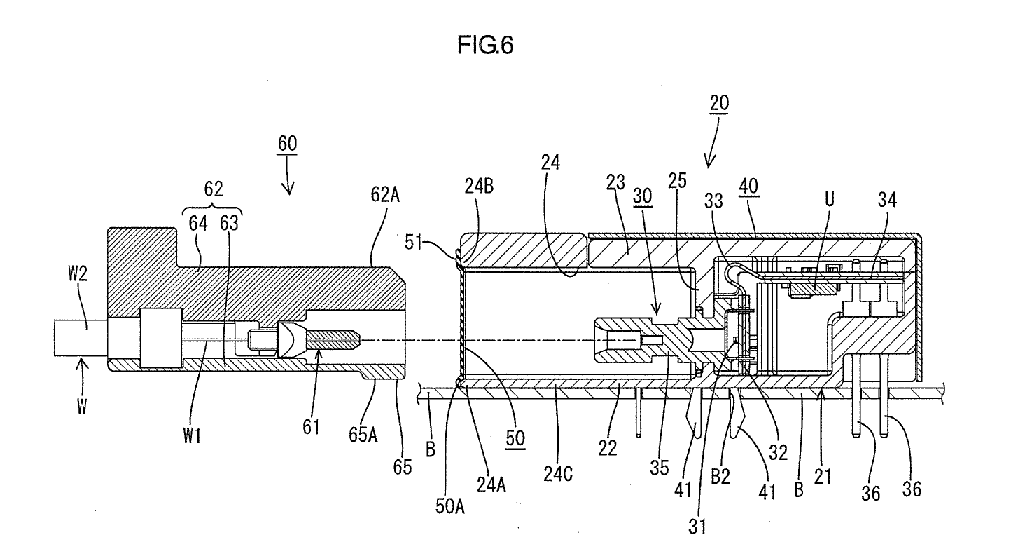

Toward the rear end of the second inner board 34, there is connected a plurality of bar-shaped metal terminals 36. One ends of the terminals 36 are connected to the conductive path formed on the second inner board 34 through the second inner board 34, as illustrated in FIG. 2. The other ends of the terminals 36 are pressed into terminal insertion holes 22A formed in the bottom wall of the housing body portion 22, and protrude downward from the bottom wall of the housing body portion 22, as illustrated in FIG. 3 and FIG. 6. The terminals 36 protruding downward from the housing body portion 22 are inserted into through-holes B1 formed in the outer board B, and are electrically connected to the conductive path on the outer board B by a known method, such as soldering.

To the front edge of the second inner board 34, there is mounted a pair of flexible printed circuit boards 33 extending forward and then bending downward, as illustrated in FIG. 3. On the front surface of the flexible printed circuit boards 33, there is laminated the first inner board 32 with the photoelectric conversion element 31 mounted thereon.

The photoelectric conversion element 31 is a light-receiving element or a light-emitting element. As a light-receiving element, a photodiode is used. As a light-emitting element, a vertical cavity surface emitting laser (VCSEL) is used. As illustrated in FIG. 2, the first inner board 32 includes a pair of boards 32A, 32A. On one of the boards 32A, a light-receiving type photoelectric conversion element 31 is mounted. On the other board 32A, a light-emitting type photoelectric conversion element 31 is mounted. On the front surface of the board 32A on which the light-receiving type photoelectric conversion element 31 is mounted, a transimpedance amplifier (not illustrated), which is electrically connected to the photoelectric conversion element 31, is mounted together with the photoelectric conversion element 31. On the other hand, on the front surface of the board 32A on which the light-emitting type photoelectric conversion element 31 is mounted, a driver (not illustrated) electrically connected to the photoelectric conversion element 31 is mounted together with the photoelectric conversion element 31.

To the first inner board 32, the sleeve members 35 are fixed, covering electronic components such as the photoelectric conversion elements 31. The sleeve members 35 are formed from a light transmissive resin used at least for optical communications (such as polyetherimide (PEI) resin, polycarbonate (PC) resin, or polymethylmethacrylate (PMMA) resin). The phrase “light transmissive” herein refers to an optical transmittance of 90% or more with respect to the wavelength used for optical communications (0.4 μm to 2 μm, for example).

The sleeve members 35 are fixed to the individual boards 32A of the first inner board 32. The front side portions of the sleeve members 35 protrude into the inner space of the accommodating portion 24 from a back wall 25 of the accommodating portion 24 in the housing 21, as illustrated in FIG. 3. The front end portion of each sleeve member 35 is configured to be fitted with the ferrule 61 of the opposite-side connector 60. When the opposite-side connector 60 and the board-side connector 20 are in a normally fitted state, the sleeve member 35 and the ferrule 61 are placed in a normally fitted state where the optical fiber W1 in the ferrule 61 and the photoelectric conversion element 31 are optically coupled to each other.

The shield shell 40 is made of a pressed sheet metal. The shield shell 40 has front and lower openings, and is configured to cover a part of the housing 21 from substantially the center to the rear thereof in the front-rear direction when assembled onto the housing 21 from above. At the lower end portions of both sides in the width direction of the shield shell 40, a pair of downwardly protruding connecting leg portions 41 is formed. The pair of connecting leg portions 41 is inserted into grounding through-holes B2 provided in the outer board B, and is connected to ground by a known method, such as soldering. Thus, the portion of the housing 21 covered by the shield shell 40 is electromagnetically shielded.

To a lower opening edge 24A of the accommodating portion 24 of the housing 21, a substantially rectangular plate-like shutter 50 made of a thin rubber material (an example of “an elastic member”) is integrally and firmly attached.

Specifically, one side of a lower edge 50A of the shutter 50 is firmly attached to the lower opening edge 24A of the accommodating portion 24. The shutter 50 may be firmly attached by, for example, melting the lower opening edge 24A of the accommodating portion 24 so as to weld the lower opening edge 24A and the shutter 50 together, or by adhering the lower opening edge 24A and the shutter 50 together using an adhesive so as to integrally fix the lower edge 50A of the shutter 50 to the lower opening edge 24A of the accommodating portion 24. Namely, according to the present embodiment, the lower edge 50A of the shutter 50, which is made of inexpensive rubber, is firmly attached to the lower opening edge 24A of the accommodating portion 24. Accordingly, compared with a conventional case where the shutter is attached to the housing using pins or hinges, the mechanism of attaching the shutter 50 can be simplified, and the number of components can be decreased. Furthermore, the manufacturing cost for the optical connector 10 can be decreased.

The shutter 50 is configured to be elastically deformed in the front-rear direction at the proximal end thereof as a fulcrum which is firmly attached to the accommodating portion 24. The shutter 50 is configured to be displaced between an open position where the shutter 50 is fallen toward the back side of the accommodating portion 24 and lies along a bottom wall 24C of the accommodating portion 24, thus opening the front-side opening of the accommodating portion 24, and a closed position where the shutter 50 is upright in an upper direction substantially perpendicular to the opening direction of the front-side opening of the accommodating portion 24, thus entering the route along which the opposite-side housing 62 enters and closing the front-side opening of the accommodating portion 24.

The height of the shutter 50 is set to be slightly greater than the height of the front-side opening of the accommodating portion 24. The width of the shutter 50 is set to be substantially the same as the width of the front-side opening of the accommodating portion 24. The two sides on the upper and lower edges of the shutter 50 are slightly extended forward from the other portions, and the upper-side edge of the shutter 50 provides a covering portion 51 configured to cover an upper opening edge 24B of the accommodating portion 24 from the front. When the shutter 50 is in the closed position and the front-side opening of the accommodating portion 24 is blocked and closed by the shutter 50, the upper opening edge 24B of the accommodating portion 24 is covered, from the front, by the covering portion 51 of the shutter 50, with both side edges in the width direction of the shutter 50 disposed along both side opening edges of the accommodating portion 24. Namely, the upper opening edge 24B of the accommodating portion 24 is covered, from the outside, by the covering portion 51, whereby the shutter 50 is prevented from being disposed in a misaligned state inclining toward the front side (toward the open position side). In this way, the front-side opening of the accommodating portion 24 can be completely blocked by the shutter 50, preventing the entry of dust into the accommodating portion 24 or the light from the optical connection member 30 from leaking outside via the accommodating portion 24.

When the opposite-side housing 62 is inserted into the accommodating portion 24, the shutter 50 is pressed rearward by the opposite-side housing 62 and falls toward the back side of the accommodating portion 24. The portion of the shutter 50 between the proximal end portion and just before the covering portion 51 contacts the upper surface of the bottom wall 24C of the accommodating portion 24. Consequently, the front side half of the bottom wall 24C of the accommodating portion 24 is covered with the shutter. The covering portion 51 is slightly spaced apart above the bottom wall 24C of the accommodating portion 24. Thus, according to the present embodiment, because the thin shutter 50 is disposed along the bottom wall 24C of the accommodating portion 24, there is no need to provide a large space for storing the shutter 50 within the accommodating portion 24, suppressing an increase in the size of the accommodating portion 24.

On the other hand, at the front-side lower end portion of the opposite-side housing 62, there is formed a catching portion 65 protruding downward in a block shape. The catching portion 65 is formed along the entire width of the opposite-side housing. The outer peripheral shape of the opposite-side housing 62, where the catching portion 65 is provided, is substantially identical to the inner peripheral shape of the accommodating portion 24. When the opposite-side housing 62 is normally fitted in the accommodating portion 24, an upper surface 62A of the opposite-side housing 62 is disposed along the roof wall of the accommodating portion 24, while a lower surface 65A of the catching portion 65 is disposed along the bottom wall 24C of the accommodating portion 24.

Namely, the lower surface at the portion of the opposite-side housing 62 rearward of the catching portion 65 is positioned higher than the lower surface 65A of the catching portion 65, so that a drawing space S is formed at a position rearward of the catching portion 65 (toward the front-side opening of the accommodating portion 24) and between the bottom wall 24C of the accommodating portion 24 and the outer wall of the opposite-side housing 62. In the drawing space S, the shutter 50 in the closed position is disposed when the covering portion 51 of the shutter 50 is disposed at the position as high as the catching portion 65.

When the opposite-side housing 62 is detached from the accommodating portion 24, due to the covering portion 51 disposed at the position as high as the catching portion 65 in the drawing space S, the catching portion 65 catches the covering portion 51 from the back side of the accommodating portion 24. Consequently, the shutter 50 lying along the lower surface of the opposite-side housing 62 is drawn out of the accommodating portion 24 through the drawing space S. Specifically, when approximately a half of the opposite-side housing 62 is drawn out of the accommodating portion 24, the catching portion 65 catches the covering portion 51 from the back side of the accommodating portion 24. Thereby, the proximal end portion of the shutter 50 is bent toward the outside (front side), and the shutter 50 is folded into two. The folded shutter 50 is then drawn completely out of the accommodating portion 24 through the drawing space S along the lower surface of the opposite-side housing 62.

The shutter 50 that has been drawn out of the accommodating portion 24 returns to the closed position by the elastic returning force of the rubber material. Consequently the front-side opening of the accommodating portion 24 is closed, with the upper opening edge 24B of the accommodating portion 24 being covered by the covering portion 51 from the front side.

The configuration of the optical connector 10 according to the present embodiment has been described. In the following, a fitting operation and a detaching operation of the optical connector 10 will be briefly described, along with a description of their working and effects.

First, when the board-side connector 20 and the opposite-side connector 60 are fitted with each other, the connectors 20 and 60 are disposed facing each other. In this step, the front-side opening of the board-side connector 20 is blocked and closed by the shutter 50, preventing the entry of dust into the accommodating portion 24 and the leakage of light from the optical connection member 30 out of the accommodating portion 24.

Then, the opposite-side housing 62 is inserted into the accommodating portion 24 of the board-side connector 20 so as to fit the connectors 20 and 60 with each other. As a result, the shutter 50 is pressed rearward by the opposite-side housing 62 and elastically falls toward the back side of the accommodating portion 24. The shutter 50 then comes into contact with the bottom wall 24C of the accommodating portion 24.

As the connectors 20 and 60 are further fitted with each other, the covering portion 51 is flattened onto the bottom wall 24C of the accommodating portion 24 by the catching portion 65. As the catching portion 65 is further moved over and across the covering portion 51, the covering portion 51 elastically returns such that the covering portion 51 and the catching portion 65 are disposed at the same height and thus the connectors 20 and 60 are placed in the normally fitted state.

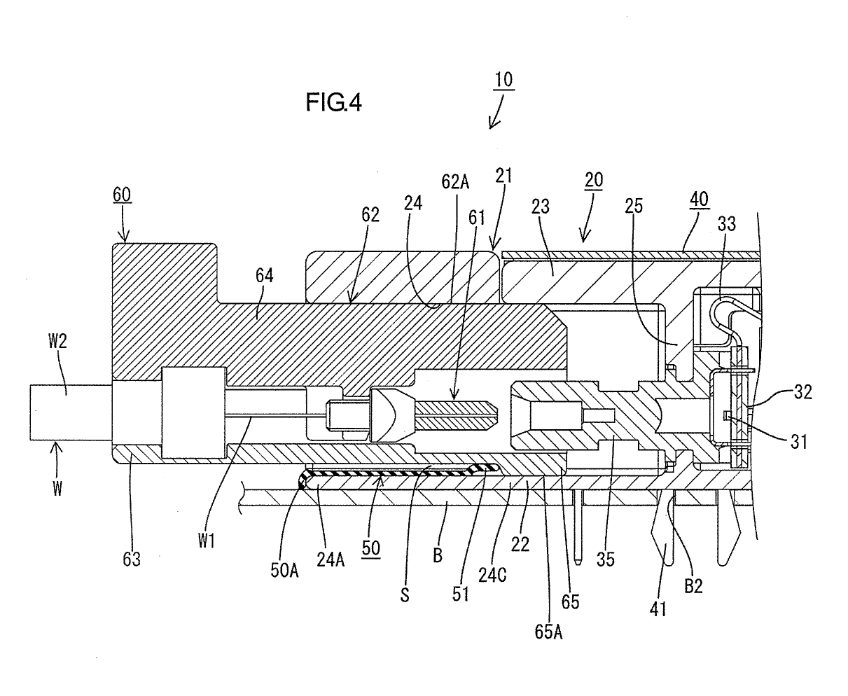

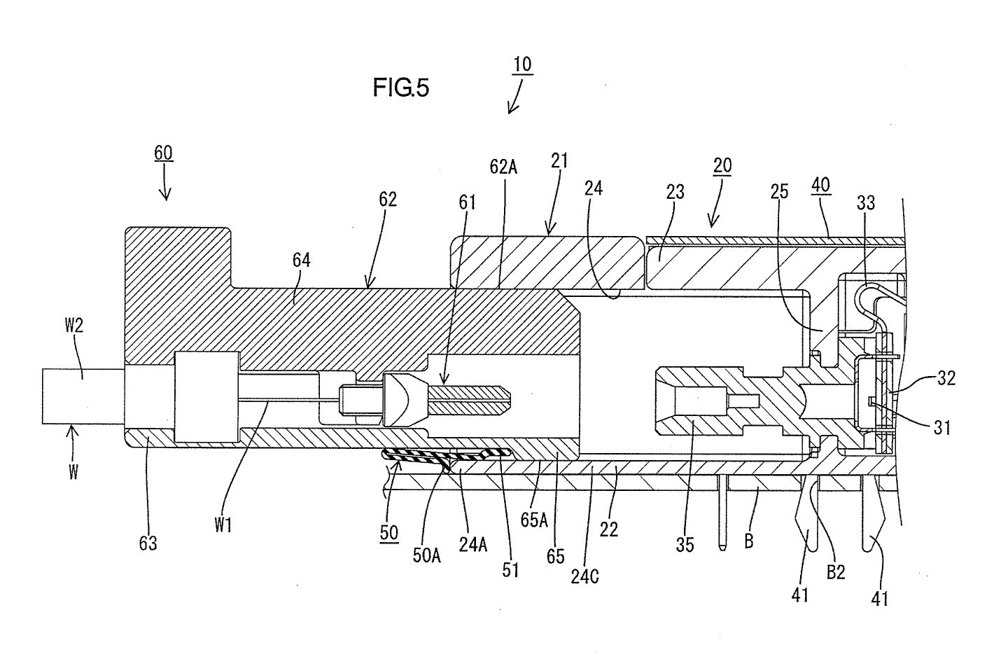

Next, when the board-side connector 20 and the opposite-side connector 60 are detached from each other, the opposite-side housing 62 is drawn out of the accommodating portion 24. In this process, when the opposite-side housing 62 is drawn out of the accommodating portion 24 by approximately half, the catching portion 65 catches the covering portion 51 from the back side of the accommodating portion 24, as illustrated in FIG. 4. As the opposite-side housing 62 is further drawn from the accommodating portion 24, the proximal end portion of the shutter 50 is bent toward the outside (front side), as illustrated in FIG. 5, whereby the shutter 50 is folded into two. The folded shutter 50 is then drawn out of the accommodating portion 24 through the drawing space S along the lower surface of the opposite-side housing 62.

Thus, according to the present embodiment, the covering portion 51 that covers the upper opening edge 24B of the accommodating portion 24 from the front side in the closed position can also serve as an engaged portion caught by the catching portion 65 of the opposite-side housing 62. In this way, the need for providing the shutter 50 with a separate engaged portion is eliminated, whereby an increase in the size of the shutter 50 can be suppressed, and the manufacturing cost for the optical connector 10 can be decreased.

As illustrated in FIG. 6, when the opposite-side housing 62 is completely detached from the accommodating portion 24, the shutter 50 is also completely drawn from the accommodating portion 24 and disposed in the closed position due to the elastic returning force of the rubber material. Namely, according to the present embodiment, the shutter 50 can be displaced from the open position to the closed position easily using the elastic returning force of the rubber material. Further, because the shutter 50 is disposed in the closed position after being completely drawn from the accommodating portion 24, the problem of the shutter 50 being caught by the inner wall and the like of the accommodating portion 24 and thereby failing to elastically return to the closed position can be prevented.

If the connectors 20 and 60 are fitted with each other over a long period of time, the shutter 50 may become stuck to the bottom wall 24C of the accommodating portion 24, or the proximal end portion of the shutter 50 may remain bent. In that case, the shutter 50 may be prevented from rising toward the closed position solely by the elastic returning force of the rubber material. According to the present embodiment, even when the shutter 50 cannot elastically return to the closed position by its own elastic returning force, the elastic return of the shutter 50 to the closed position is facilitated by the catching portion 65 configured to catch the shutter 50.

If the catching portion is configured merely to lightly catch the shutter 50 so as to simply trigger the elastic return of the shutter, the shutter may be caught by the inner wall and the like of the accommodating portion 24 as the shutter is elastically returned, thus failing to completely return to the closed position. According to the present embodiment, the shutter 50 is disposed in the closed position after being completely drawn from the accommodating portion 24 and, therefore, the shutter 50 is reliably disposed in the closed position.

As described above, in the optical connector 10 according to the present embodiment, the shutter 50 made of an inexpensive rubber material is firmly attached to the lower opening edge 24A of the accommodating portion 24. Consequently, when the housings 21 and 62 are fitted with each other, the shutter 50 falls toward the back side of the accommodating portion 24 and opens the front-side opening of the accommodating portion 24. When the housings 21 and 62 are detached from each other, the shutter 50 is drawn from the accommodating portion 24 and reliably closes the front-side opening of the accommodating portion 24. Thus, compared with conventional optical connectors, the shutter mechanism is simplified by greatly reducing the number of components, thereby suppressing an increase in the size of the optical connector 10 or an increase in the number of assembly steps. Furthermore, the manufacturing cost for the optical connector 10 can be decreased.

Even when the shutter 50 remains in contact with the bottom wall 24C of the accommodating portion 24 and cannot elastically return to the closed position by the elastic returning force of the shutter 50 itself, the elastic return of the shutter 50 to the closed position can be facilitated by catching the covering portion 51 of the shutter 50 by the catching portion 65 of the opposite-side housing 62. Thus, the shutter 50 can be reliably disposed in the closed position.

Furthermore, according to the present embodiment, the shutter 50 is configured to be completely drawn out of the accommodating portion 24 using the drawing space S formed between the bottom wall 24C of the accommodating portion 24 and the lower surface of the opposite-side housing 62. Thus, when the shutter 50 is drawn by the catching portion 65, the shutter 50 is suppressed from remaining in the accommodating portion 24 due to the shutter 50 being crushed into a roll or warped between the bottom wall 24C of the accommodating portion 24 and the lower surface of the opposite-side housing 62.

### Other Embodiments

The present invention is not limited to the embodiment described above with reference to the drawings, and may include the following embodiments, for example, in the technical scope of the present invention.

(1) In the foregoing embodiment, the board-side connector 20 is provided with the shutter 50. However, the present invention is not limited to such configuration, and the shutter may be applied to a connector connected to an end of an optical cable, for example.

(2) In the foregoing embodiment, the front-side opening of the accommodating portion 24 has a substantially rectangular shape. However, the present invention is not limited to such configuration, and the front-side opening of the accommodating portion may have, for example, a circular or square shape.

(3) In the foregoing embodiment, the shutter 50 is made of a rubber material. However, the present invention is not limited to such configuration, and the shutter 50 may be made of other materials, such as resin, which have elasticity similar to rubber.

(4) In the foregoing embodiment, the shutter 50 is mounted to the front-side opening edge of the accommodating portion 24. However, the present invention is not limited to such configuration, and the shutter may be mounted to, for example, the inner wall of the accommodating portion.

(5) In the foregoing embodiment, the shutter 50 is disposed at the closed position after being completely drawn from the accommodating portion 24. However, the present invention is not limited to such configuration. For example, the shutter may not be completely drawn from the accommodating portion as long as the opening of the accommodating portion can be completely closed by the shutter.

(6) In the foregoing embodiment, the covering portion 51 is provided at one side on the upper-side edge of the shutter 50. However, the present invention is not limited to such configuration, and the covering portions may be provided, for example, at side edges on both sides of the shutter.

(7) In the foregoing embodiment, the catching portion 65 has a block configuration. However, the present invention is not limited to such configuration, and the catching portion may have, for example, a pawl shape.

### REFERENCE SIGNS LIST

10: Optical connector
20: Board-side connector (one connector)
24: Accommodating portion
50: Shutter
51: Covering portion
60: Opposite-side connector (the other connector)
65: Catching portion

1. An optical connector comprising a pair of optical connectors including one connector and the other connector to be fitted with each other, wherein
the one connector includes an accommodating portion configured to internally fit with the other connector and having an opening toward the other connector; and
the accommodating portion is provided with an elastically deformable shutter configured to
elastically fall toward a back side of the accommodating portion and to open the opening of the accommodating portion by being pressed by the other connector when the one connector and the other connector are fitted with each other, and
close the opening of the accommodating portion by entering an entry route of the other connector when the other connector is detached.

2. The optical connector according to claim 1, wherein
the other connector includes a catching portion, and
the catching portion is configured to catch the shutter so as to draw the shutter from the back side of the accommodating portion toward the outside of the accommodating portion when the one connector and the other connector are detached from each other.

3. The optical connector according to claim 2, wherein
the opening of the accommodating portion has a substantially rectangular shape, and
the shutter is made of a plate-like elastic member and integrally firmly attached to one side of an opening edge of the accommodating portion.

4. The optical connector according to claim 3, wherein the shutter is made of a rubber material.

5. The optical connector according to claim 4, wherein the shutter includes a covering portion configured to cover the opening edge of the accommodating portion from outside.

6. The optical connector according to claim 5, wherein
the other connector includes a catching portion,
the covering portion is formed to be slightly spaced apart from an inner wall of the accommodating portion when the shutter is elastically fallen toward the back side of the accommodating portion, and
the catching portion is configured to draw the shutter by catching the covering portion.

7. The optical connector according to claim 1, wherein
the opening of the accommodating portion has a substantially rectangular shape, and
the shutter is made of a plate-like elastic member and integrally firmly attached to one side of an opening edge of the accommodating portion.

8. The optical connector according to claim 1, wherein the shutter is made of a rubber material.

9. The optical connector according to claim 1, wherein the shutter includes a covering portion configured to cover the opening edge of the accommodating portion from outside.

10. The optical connector according to claim 9, wherein
the other connector includes a catching portion,
the covering portion is formed to be slightly spaced apart from an inner wall of the accommodating portion when the shutter is elastically fallen toward the back side of the accommodating portion, and
the catching portion is configured to draw the shutter by catching the covering portion.
